(19) United States
(12) Patent Application Publication
(10) Pub. No.: US 2006/0082290 A1
(43) Pub. Date: Apr. 20, 2006

(54) Method of forming an electrode, display apparatus and method of manufacturing the same

(75) Inventor: Ameen K. Saafir, Gyeonggi-do (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/197,674

(22) Filed: Aug. 3, 2005

(30) Foreign Application Priority Data
Oct. 20, 2004 (KR) 10-2004-84131

(51) Int. Cl. H01J 1/62; H01J 63/04

(52) U.S. Cl. 313/504

(57) ABSTRACT

A display apparatus includes a substrate, a metal electrode and a transparent electrode. The metal electrode is disposed over the substrate. The metal pattern includes metal having a work function of at least about 4.0 eV and optical reflectivity of at least about 90%. The transparent electrode is disposed over the substrate such that the transparent electrode overlays the metal pattern. The metal electrode may include gold or silver. The metal electrode may be formed through an ink-jet printing method or a screen printing method. By using a high-reflectivity metal, luminance is enhanced.

### CROSS-REFERENCE TO RELATED APPLICATIONS

This application relies for priority upon Korean Patent Application No. 2004-84131 filed on Oct. 20, 2004, the content of which is herein incorporated by reference in its entirety.

### BACKGROUND OF THE INVENTION

1. Field of the Invention

The present invention relates to a method of forming an electrode, a display apparatus having the electrode and a method of manufacturing the display apparatus. More particularly, the present invention relates to a method of forming an electrode having enhanced luminance, a display apparatus having the electrode and a method of manufacturing the display apparatus.

2. Description of the Related Art

An organic light emitting display (OLED) apparatus displays an image by using an organic light emitting layer. The OLED apparatus includes a first electrode and second electrode, and an organic light emitting layer that is disposed between the first and second electrodes. Since light generated by the organic light emitting layer passes through one of the first and second electrodes to display an image, at least one of the first and second electrodes is optically transparent.

The OLED apparatus may be classified as either a conventional type OLED apparatus (where light passes through a bottom electrode) or a top emission type OLED, according to a light emitting direction.

According to the conventional type OLED apparatus, an organic light emitting layer is disposed below a cathode that is opaque, and an anode is disposed below the organic light emitting layer. A transparent substrate is disposed below the anode.

According to the top emission type OLED apparatus, an organic light emitting layer is disposed below a cathode that is optically transparent, an anode is disposed below the organic light emitting layer, and a substrate is disposed below the anode. The anode and the substrate are opaque.

The top emission type OLED apparatus has many merits such as a relatively high aperture ratio, a relatively high luminance, a relatively long lifespan, etc. in comparison to the conventional type OLED apparatus.

The top emission type OLED employs an anode including aluminum. However, aluminum is not conducive to achieving a bright image because it has a relatively lower reflectivity that results in low luminance. Thus, a top emission type OLED having more enhanced luminance is under research.

### SUMMARY OF THE INVENTION

The present invention provides a display apparatus of enhanced luminance.

The present invention also provides a method of forming an electrode without using an etching process for patterning.

The present invention also provides a method of manufacturing the above display apparatus.

In one aspect, the present invention is a display apparatus including a substrate, a metal electrode and a transparent electrode. The metal electrode is disposed over the substrate. The metal pattern includes metal having a work function of at least about 4.0 eV and optical reflectivity of substantially equal to or higher than about 90%. The transparent electrode is disposed over the substrate and the metal pattern.

The display apparatus may include a switching device electrically connected to the metal pattern.

The display apparatus may include an organic light emitting layer disposed between the metal electrode and the transparent electrode. The organic light emitting layer emits light when a voltage is applied to the transparent electrode and the metal electrode through the switching device.

The metal electrode may include at least one of gold (Au) and silver (Ag).

The metal electrode may be formed through one of an ink-jet printing method and a screen printing method.

The metal electrode may act as an anode providing the organic light emitting layer with holes, and the transparent electrode may act as a cathode providing the organic light emitting layer with electrons.

In another aspect, the invention is a display apparatus including a substrate, a metal electrode, an organic light emitting layer, a transparent electrode and a switching device. The metal electrode is disposed on the substrate. The metal pattern is formed using nano-particles. The organic light emitting layer is formed on the metal electrode. The transparent electrode is formed on the organic light emitting layer. The switching device applies a voltage to the metal electrode.

In yet another aspect, the invention is a method of forming an electrode. A metal nano-particle solution is discharged onto a region above the electrode and is dried to form the electrode.

The metal nano-particle solution may include gold (Au) or silver (Ag), and may be dropped on the region through an ink-jet printing method or a screen printing method. The metal nano-particle solution may be dried by irradiating heat rays.

In yet another aspect, the invention is a method of manufacturing a display device. A metal nano-particle solution is discharged onto a substrate to form a first electrode. An organic light emitting layer is formed on the first electrode, and a second electrode is formed on the organic light emitting layer.

A metal nano-particle solution may be dried to form the first electrode. The metal nano-particle solution may include metal having a work function that is at least about 4 eV. The metal nano-particle solution may include a metal having an optical reflectivity that is at least about 90%, such as gold (Au) or silver (Ag). The metal nano-particle solution may be discharged onto the substrate through an ink-jet printing method or a screen printing method.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a layout illustrating a display apparatus according to an exemplary embodiment of the present invention;

FIG. 2 is a cross-sectional view taken along a line I-I′ in FIG. 1; and

FIGS. 3A to 3F are cross-sectional views illustrating a method of manufacturing a display apparatus according to an exemplary embodiment of the present invention.

### DESCRIPTION OF THE EMBODIMENTS

It should be understood that the exemplary embodiments of the present invention described below may be modified in many different ways without departing from the inventive principles disclosed herein, and the scope of the present invention is therefore not limited to these particular flowing embodiments. Rather, these embodiments are provided so that this disclosure will be thorough and complete, and will fully convey the concept of the invention to those skilled in the art by way of example and not of limitation.

Hereinafter, the embodiments of the present invention will be described in detail with reference to the accompanying drawings. It is noted that various changes, substitutions and alterations can be made herein without departing from the spirit and scope of the invention as defined by embodiments that will be described below. The embodiments are only examples for showing the sprit of the present invention to a person skilled in the art. In the figures, a thickness of layers is exaggerated for clarity. When a first layer is “disposed on” or “disposed over” a second layer, other layers may be disposed therebetween. The term “disposed directly on” means that nothing is disposed therebetween.

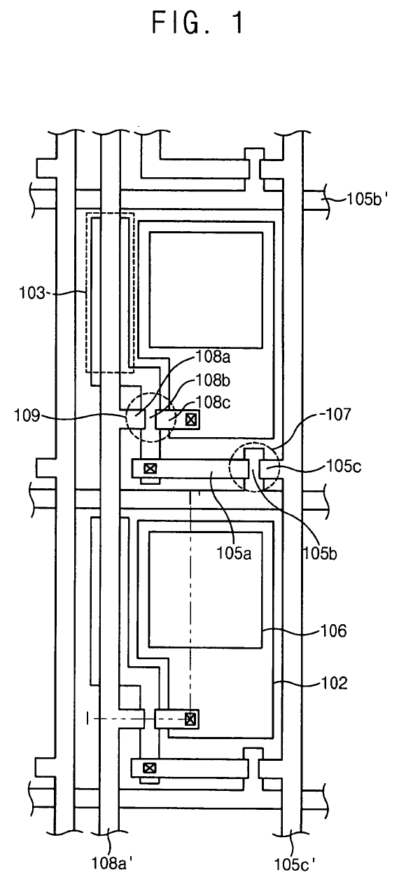

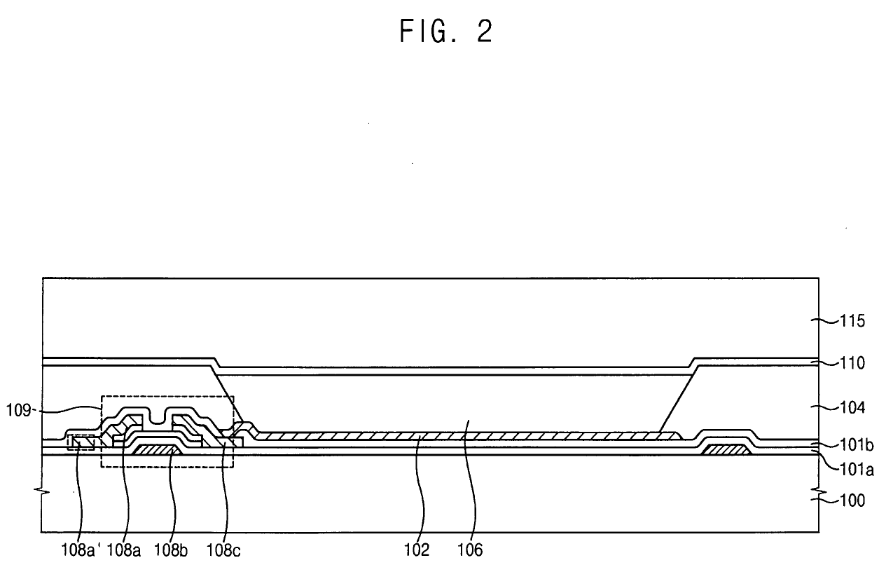

FIG. 1 is a layout illustrating a display apparatus according to an exemplary embodiment of the present invention, and FIG. 2 is a cross-sectional view taken along a line I-I′ in FIG. 1.

Referring to FIGS. 1 and 2, a display apparatus according to an exemplary embodiment of the present invention includes a substrate 100 and an organic light emitting device formed thereon.

The substrate includes a material such as glass, triacetylcellulose; (TAC), polycarbonate (PC), polyethersulfone (PES), polyethyleneterephthalate (PET), polyethylenenaphthalate (PEN), polyvinylalcohol (PVA), polymethylmethacrylate (PMMA), cyclo-olefin polymer (COP), a mixture thereof, etc.

The organic light emitting device includes a gate insulation layer 101a, a first insulation layer 101b including an organic material or an inorganic material, an anode 102, a second insulation layer 104, an organic light emitting layer 106, a switching transistor 107, a driving transistor 109 and a cathode 110.

The switching transistor 107 includes a first source electrode 105c, a first gate electrode 105b and a first drain electrode 105a. The first source electrode 105c is electrically connected to a data line 105c′, so that the data line 105c′ applies a data signal provided by a driving circuit (not shown) to the first source electrode 1 05c. The first gate electrode 105b is disposed on the substrate 100, and electrically connected to a gate line 105b′, so that the gate line 105b′ applies a gate signal provided by the driving circuit to the first gate electrode 105b. The first drain electrode 105a is spaced apart from the first source electrode 105c. A first semiconductor layer (not shown) is disposed between the first drain electrode 105a and the first source electrode 105c.

The driving transistor 109 includes a second source electrode 108a, a second gate electrode 108b and a second drain electrode 108c. The second source electrode 108a is electrically connected to a bias voltage line 108a′. The second gate electrode 108b is disposed on the substrate 100. The second gate electrode 108b is electrically connected to the first drain electrode 105a of the switching transistor 107 through a sub contact hole. The second drain electrode 108c is spaced apart from the second source electrode 108a. A second semiconductor layer (not shown) is disposed between the second drain electrode 108c and the second source electrode 108a.

When a data voltage and a gate voltage are applied to the data line 105c′ and the gate line 105b′, the data voltage is applied to the second gate electrode 108b through the first source electrode 105c, the first semiconductor layer and the first drain electrode 105a. When the data voltage is applied to the second gate electrode 108b, a channel is generated at the second semiconductor layer, so that a drain voltage is applied to the second drain electrode 108c.

The gate insulation layer 101a electrically insulates the first gate electrode 105b, the gate line 105b′ and the second gate electrode 108b from the first source electrode 105a, the data line 105c′ the first drain electrode 105c, the second source electrode 108a, the bias voltage line 108a′ and the second drain electrode 108c. The gate insulation layer 101a includes an optically transparent material such as silicon oxide, silicon nitride, etc.

The first insulation layer 101b including an inorganic material or an organic material is disposed on the substrate 100 having the switching transistor 107, the driving transistor 109, the gate line 105b′, the data line 105c′ and the bias voltage line 108a′ formed thereon. The first insulation layer 101b includes a contact hole that electrically connects the second drain electrode 108c to the anode 102. The first insulation layer 101b includes an optically transparent material such as silicon oxide, silicon nitride, etc., or organic material for planarization.

A portion of the second gate electrode 108 is overlapped with the bias voltage line 108a′ to form a storage capacitor 103. The storage capacitor maintains a voltage between the anode 102 and the cathode 110 for one frame.

The anode 102 is disposed in a region defined by the bias voltage line 108a′, the gate line 105b′ and the data line 105c′.

The anode 102 includes an electrically conducting material.

In order to enhance the luminance of the display apparatus, the display apparatus according to the present invention adopts a material having a relatively high reflectivity. Aluminum, which is commonly used in a conventional anode, has an optical reflectivity of only about 71%, which is not high enough to achieve the desired luminance level.

When an optical reflectivity is substantially equal to or higher than about 90%, a satisfactory luminance level is obtained. In order to find the appropriate material for the anode, various metals having high reflectivity had been tested. Test results indicate that the work function of the material also affects the material's performance in the display device of the invention. More specifically, when a work function is lower than about 4.0 eV, holes are not emitted easily from the metal. Thus, a work function of at least about 4 eV is required.

Especially, according to the top emission type OLED apparatus, the anode includes metal having an optical reflectivity of substantially equal to or higher than about 90%, and a relatively high work function of substantially equal to or higher than about 4 eV for receiving a hole. Gold (Au) and silver (Ag) satisfy the two conditions.

Therefore, the anode 102 according to the present invention includes, for example gold (Au) or silver (Ag). However, forming the anode 102 is very different because gold and silver are noble metals that are chemically stable, so that patterning gold or silver layer by etching is very hard. Therefore, according to the present invention, the anode 102 is formed through an ink-jet printing method or a screen printing method using nano-particles. According to the ink-jet printing method or the screen printing method, the metal layer may be formed on a desired position. Therefore, no etching process is required. Detailed method will be explained in detail at the following.

The nano-particles may be obtained from ‘Cabot Corporation’ of USA (e.g., Product No. AG-IJ-G-100-S1), or ‘Harima Chemicals, Inc.’ of Japan (NP Series).

The second insulation layer 104 is formed on the first insulation layer 101b. The second insulation layer 104 includes an opening that exposes the anode 102.

The organic light emitting layer 106 is formed on the anode 102 exposed through the opening of the second insulation layer 104. The organic light emitting layer 106 includes light emitting polymer such as polyphenylvinylene derivatives, polyfluorene derivatives, etc. The organic light emitting layer 106 emits one of red light, green light and blue light. The organic light emitting layer 106 includes, for example, a hole-injection layer, a hole-transportation layer, a light emitting layer, an electron-transportation layer and an electron-injection layer.

The cathode 110 is formed on the organic light emitting layer 106 and the second insulation layer 104. A reference voltage is applied to the cathode 110. The cathode 110 includes an optically transparent and electrically conductive material such as indium tin oxide (ITO), indium zinc oxide (IZO), zinc oxide (ZO), etc.

The second drain electrode 108c applies the drain voltage to the anode 102 through the contact hole. Therefore, electric currents flow between the anode 102 and the cathode 110 through the organic light emitting layer 106. When a hole provided from the anode 102 is combined with an electrode provided from the cathode 110 at the organic light emitting layer 106, an exciton having high energy is generated. When the exciton is transferred to a ground state, light is generated.

The protection layer 115 is formed on the cathode 110 to protect the organic light emitting device. The protection layer 115 isolates the organic light emitting layer 106 from oxygen gas (O₂), water vapor (H₂O), etc. The protection layer 115 also absorbs water vapor (H₂O) in the internal space of the protection layer 115 or in a space adjacent to the protection layer 115, etc. The protection layer 115 corresponds to, for example, an inorganic layer, an organic layer, a desiccant layer, or a multiple layer thereof.

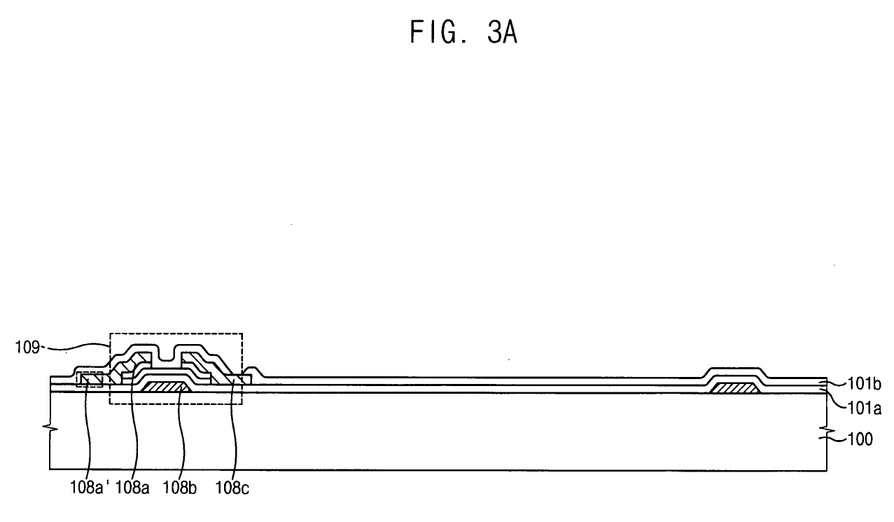

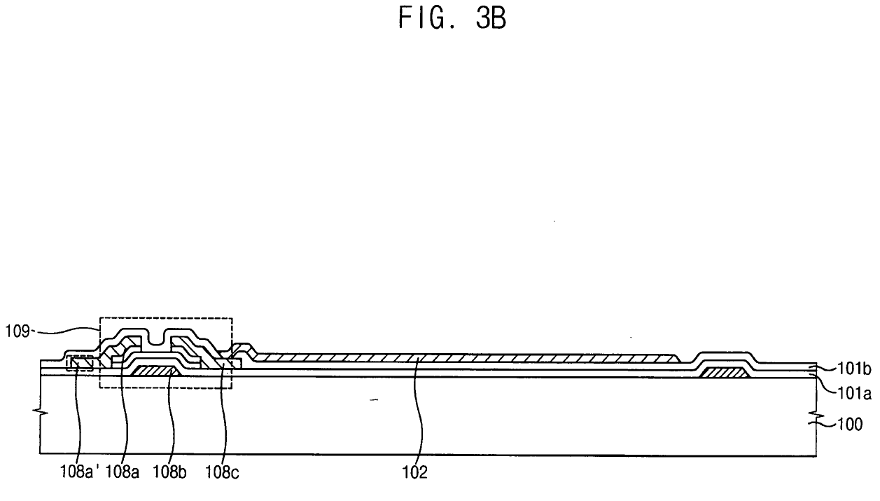

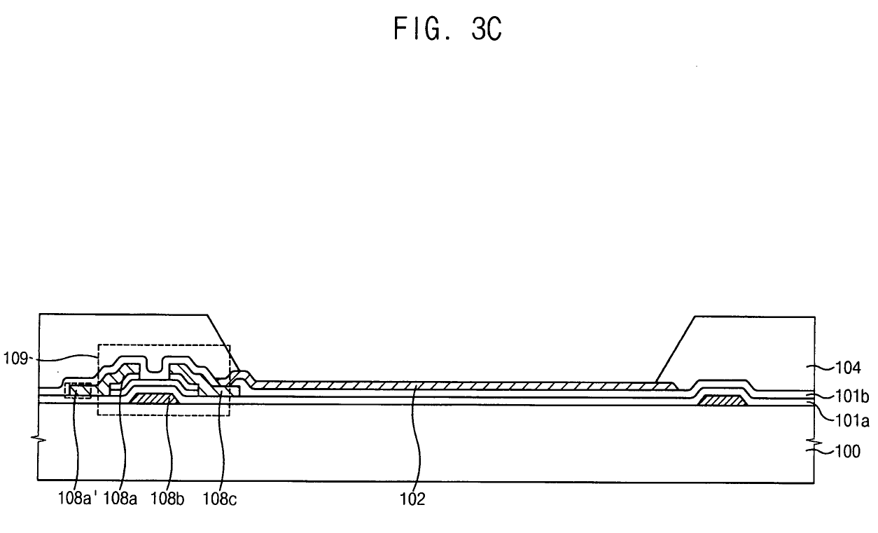

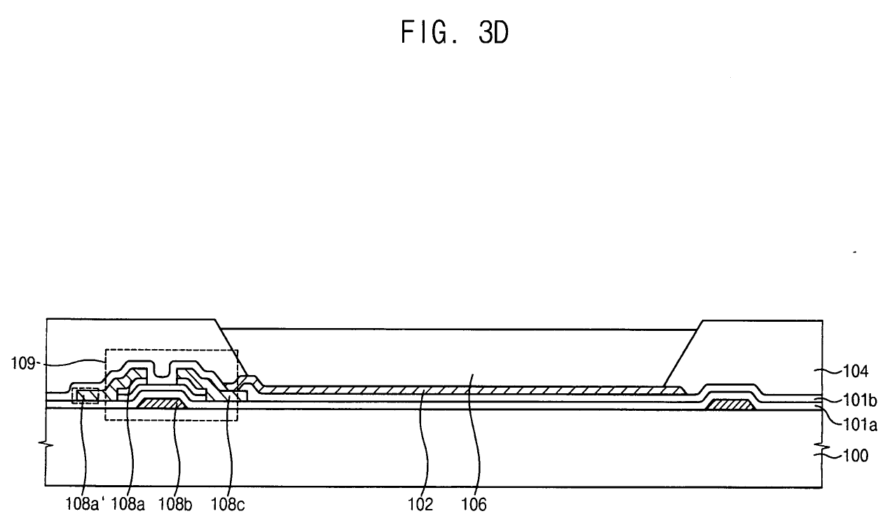

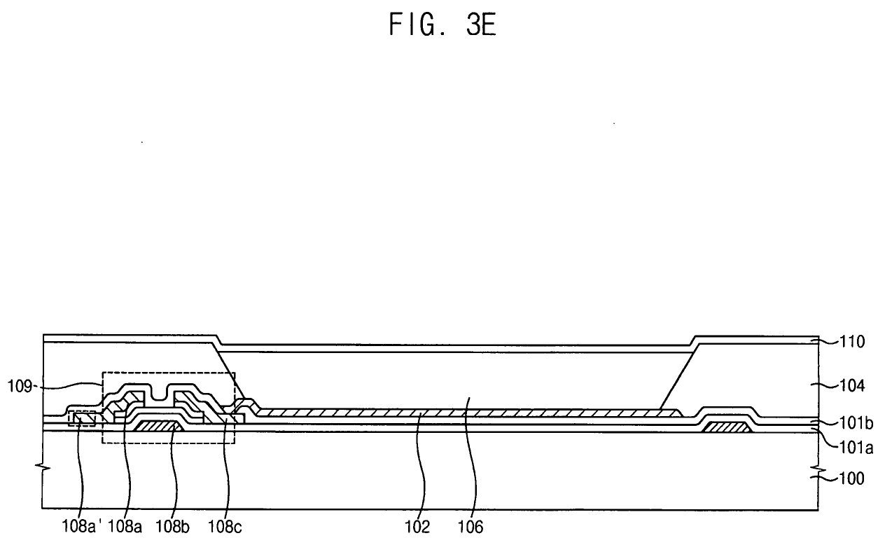

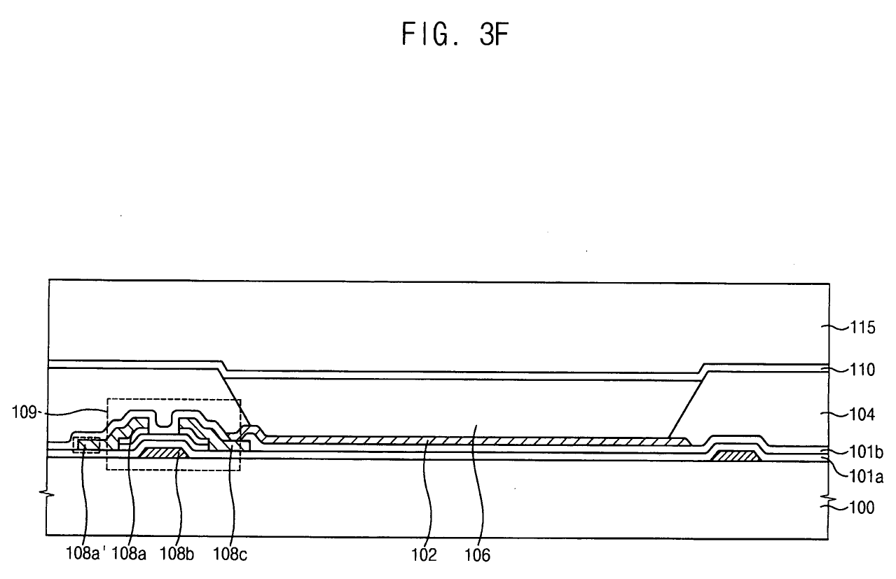

FIGS. 3A to 3F are cross-sectional views illustrating a method of manufacturing a display apparatus according to an exemplary embodiment of the present invention.

Referring to FIGS. 1 and 3A, a metal layer (not shown) is formed on the substrate 100, and the metal layer is patterned to form the first gate electrode 105b, the gate line 105b′ and the second gate electrode 108b.

An optically transparent dielectric layer (not shown) is formed on the substrate 100 having the first gate electrode 105b, the gate line 105b′ and the second gate electrode 108b formed thereon. A portion of the optically transparent dielectric layer is removed to form the sub contact hole that exposes a portion of the second gate electrode 108b to form the gate insulation layer 101a having the sub contact hole.

An amorphous silicon pattern is formed on the gate insulation layer 101a, and an n+ amorphous silicon pattern is formed on the amorphous silicon pattern to form the first and second semiconductor layers.

A metal layer (not shown) is formed on the gate insulation layer 101a having the first and second semiconductor layers are formed thereon, and the metal layer is patterned to form the first source electrode 105c, the data line 105c′, the first drain electrode 105a, the second source electrode 108a, the bias voltage line 108a′, the second drain electrode 108c and the storage capacitor 103. Therefore, formation of the switching transistor 107 including the first gate electrode 105b, the first drain electrode 105a, the first source electrode 105c and the first semiconductor pattern, and the driving transistor 109 including the second gate electrode 108b, the second drain electrode 108c, the second source electrode 108aand the second semiconductor layer are completed.

Then, an optically transparent dielectric layer is formed on the substrate 100 having the switching transistor 107, the driving transistor 109, the gate line 105b′ the data line 105c′ and the bias voltage line 108a′. A portion of the optically transparent dielectric layer is removed to form the contact hole that exposes a portion of the second drain electrode 108c to form the first insulation layer 101b.

Referring to FIG. 3B, a metal nano-particle solution including gold (Au) or silver (Ag) is coated on an electrode-forming region, for example, through an ink-jet printing method or a screen printing method to form a conducting pattern. By using the ink-jet printing method or the screen printing method, the process of patterning a metal layer in order to form an electrode can be omitted.

According to the ink-jet printing method, the metal nano-particle solution is contained in a container, and the metal nano-particle solution is sprayed through a nozzle along an electrode pattern to form an electrode.

According to the screen printing method, a mask having an opening above the electrode is disposed on the first insulation layer 101b, and then metal nano-particle solution is dropped onto the opening and squeezed to be spread. The mask includes, for example polyester, metal, etc.

Then, the substrate 100 having the metal nano-particle solution dropped thereon is transferred to a furnace that dries the metal nano-particle solution by irradiating infrared light (or heat rays) or air heating to form the anode 102. The anode 102 is electrically connected to the second drain electrode 108c through the contact hole.

Referring to FIG. 3C, an organic layer including photoresist is formed on the first insulation layer 101b having the anode 102 formed thereon, and a portion of the organic layer is removed through, for example a photolithography to expose the anode 102. As a result, formation of the second insulation layer 104 having the opening that exposes the anode 102 is completed.

Referring to FIG. 3D, an organic light emitting material is dropped onto the opening to form the organic light emitting layer 106.

Referring to FIG. 3E, an optically transparent and electrically conductive layer is formed on the organic light emitting layer 106 and the second insulation layer 104 to form the cathode 110.

Therefore, formation of the organic light emitting device including the gate insulation layer 101a, the first insulation layer 101b, the anode 102, the second insulation layer 104, the organic light emitting layer 106, the switching transistor 107, the driving transistor 109 and the cathode 110 is completed.

Referring to FIG. 3F, an adhesive layer (not shown) including a photo setting resin is formed on the substrate 100 having the organic light emitting device formed thereon.

A silicon oxide (SiOx) is deposited on the cathode 110 to form an inorganic layer, and a damp-proof epoxy is deposited on the inorganic layer to form an organic layer. As a result, the protection layer 115 including the inorganic layer and the organic layer is completed.

Therefore, the display apparatus having the organic light emitting device and the protection layer 115 is completed.

The method of forming an electrode is herein described in the context of an OLED apparatus. However, the method may be adopted for manufacturing an LCD apparatus.

According to the present invention, the display apparatus employs an anode including gold or silver having relatively high reflectivity, so that luminance is enhanced.

According to the present invention, an electrode is formed by a metal nano-particle solution through the ink-jet printing method or a screen printing method. Therefore, no additional etching process is required to form the electrode. Furthermore, the nano-metal solution including gold (Au) or silver (Ag) is dropped only onto a region above the electrode, reducing the overall manufacturing cost.

Having described the exemplary embodiments of the present invention and its advantages, it is noted that various changes, substitutions and alterations can be made herein without departing from the spirit and scope of the invention as defined by the appended claims.

What is claimed is:

1. A display apparatus comprising:
a substrate;
a metal electrode disposed over the substrate, the metal electrode including metal having a work function of at least about 4.0 eV and optical reflectivity of at least about 90%; and
a transparent electrode disposed over the substrate and the metal pattern.

2. The display apparatus of claim 1, further comprising a switching device electrically connected to the metal pattern.

3. The display apparatus of claim 2, further comprising an organic light emitting layer disposed between the metal electrode and the transparent electrode, the organic light emitting layer emitting light when a voltage is applied to the transparent electrode and the metal electrode through the switching device.

4. The display apparatus of claim 1, wherein the metal electrode comprises at least one of gold (Au) and silver (Ag).

5. The display apparatus of claim 4, wherein the metal electrode is formed through one of an ink-jet printing method and a screen printing method.

6. The display apparatus of claim 1, wherein the metal electrode corresponds to an anode providing the organic light emitting layer with holes, and the transparent electrode corresponds to a cathode providing the organic light emitting layer with electrons.

7. A display apparatus comprising:
a substrate;
a metal electrode disposed on the substrate, the metal electrode being formed by nano-particles;
an organic light emitting layer formed on the metal electrode;
a transparent electrode formed on the organic light emitting layer; and
a switching device applying a voltage to the metal electrode.

8. The display apparatus of claim 1, wherein the nano-particles correspond to one of gold (Au) particles and silver (Ag) particles.

9. The display apparatus of claim 8, wherein the metal electrode is formed through one of an ink-jet printing method and a screen printing method using one of the gold (Au) particles and the silver (Ag) particles.

10. The display apparatus of claim 7, wherein the metal electrode corresponds to an anode providing the organic light emitting layer with holes, and the transparent electrode corresponds to a cathode providing the organic light emitting layer with electrons.

11. A method of forming an electrode, comprising:
discharging a metal nano-particle solution onto a region above the electrode; and
drying the metal nano-particle solution to form the electrode.

12. The method of claim 11, wherein the metal nano-particle solution comprises at least one of gold (Au) and silver (Ag).

13. The method of claim 11, wherein the metal nano-particle solution is dropped on the region through an ink-jet printing method or a screen printing method.

14. The method of claim 11, wherein the metal nano-particle solution is dried by irradiating heat rays.

15. A method of manufacturing a display device, comprising:
discharging a metal nano-particle solution onto a substrate to form a first electrode.
forming an organic light emitting layer on the first electrode; and
forming a second electrode on the organic light emitting layer.

16. The method of claim 15, further comprising drying the metal nano-particle solution to form the first electrode.

17. The method of claim 15, wherein the metal nano-particle solution comprises metal having a work function that is substantially equal to or larger than about 4.0 eV.

18. The method of claim 15, wherein the metal nano-particle solution comprises metal having an optical reflectivity that is substantially equal to or larger than about 90%.

19. The method of claim 15, wherein the metal nano-particle solution comprises at least one of gold (Au) and silver (Ag).

20. The method of claim 15, wherein the metal nano-particle solution is discharged onto the substrate through an ink-jet printing method or a screen printing method.

21. The method of claim 15, wherein the organic light emitting layer is formed by:
forming a hole-injection layer on the first electrode;
forming a hole-transportation layer on the hole-injection layer;
forming a light emitting layer on the hole-transportation layer;
forming an electron-transportation layer on the light emitting layer; and
forming an electron-injection layer on the electron-transportation layer.
